(19) United States
(12) Patent Application Publication
(10) Pub. No.: US 2007/0024688 A1
(43) Pub. Date: Feb. 1, 2007

(54) Disposable printer

(76) Inventors: Craig Rochford, Hampshire (GB); Sean Rochford, Hampshire (GB); Mark Andrew Woodiwiss, Cardiff (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/557,019

(22) PCT Filed: Apr. 26, 2004
(86) PCT No.: PCT/GB04/01777

§ 371 Date: Nov. 16, 2005

(30) Foreign Application Priority Data
Apr. 30, 2003 (GB) 0309913.2

(51) Int. Cl. B41J 29/13

(52) U.S. Cl. 347/108

(57) ABSTRACT

The present invention relates to printing apparatus and particularly, but not exclusively, to printing apparatus for use with personal computers and portable computing devices (such as laptops). The invention provides a printer chassis (8) manufactured from a disposable and biodegradable material. A further aspect of the invention provides a printer assembly comprising the aforementioned chassis (8) and at least one sheet of paper (10) to be printed, said paper (10) being located within the chassis. The invention thereby provides a printer which is relatively inexpensive to manufacture and convenient to use.

The present invention relates to printing apparatus and particularly, but not exclusively, to printing apparatus for use with personal computers and portable computing devices (such as laptops).

Printing devices are now widely used in connection with desk top and laptop personal computers, and personal digital assistants. There are many types of printers available ranging from relatively sophisticated and expensive laser printers to more basic and less expensive ink jet printers. It will be appreciated that printers use consumable items such as paper and ink which must be periodically replaced in order for the printer to continue functioning. This can be particularly inconvenient in circumstances where a printer is to be transported and used at a temporary location in connection with, for example, a laptop computer. In these circumstances, the normal source of replacement paper and ink will generally not be readily available and, if either the paper or ink in the printer is exhausted, then the printer will often be rendered useless.

It will also be appreciated that large quantities of paper and ink are used by printers in computer related applications and this leads to a large quantity of material waste associated with the packaging for the replacement paper and ink. This packaging increases the costs associated with running a printer and, unless the packaging is of a suitable material, the heavy use of printing paper and ink can have an adverse affect on the environment. Furthermore, it will be appreciated that the cost of a conventional printer is in no small part due to the relatively complex construction of the printer chassis which is generally made of sheet metal encapsulated by a fascia made from an injection moulded plastics material. This relatively expensive component merely serves to provide a base upon which the components essential for undertaking the printing function are mounted. The chassis itself may be considered to have a secondary function which perhaps does not justify the expense associated with its manufacture.

It is an object of the present invention to provide an improved printer which is relatively inexpensive to manufacture and convenient to use.

A first aspect of the present invention provides a printer chassis manufactured from a disposable and biodegradable material.

The chassis is preferably manufactured from pulp fibre. The chassis may also comprise a honeycomb construction. It is particularly desirable for an outer surface of the chassis to be covered in a waterproofing material. This waterproofing material may completely encapsulate the chassis. Furthermore, a line of perforations may be provided in the waterproofing material adjacent an aperture in the chassis, a portion of said waterproofing material covering said aperture and said line of weakness extending around said aperture so as to allow ready removal of said portion of material. Ideally, the waterproofing material is bonded to the chassis and is preferably of wax paper.

The chassis may comprise means for mounting on the chassis a motor for driving relative movement between a printer head and paper to be printed. The aforementioned means for mounting a motor may comprise means for releasably securing a motor to the chassis. The releasable securing means ideally comprises a resilient snap lock clip. It is particularly desirable for said means for mounting a motor to comprise a rail slider upon which, in use, a motor may be located and slid into a use position. Also, an electrical connector may be mounted on the chassis so as to receive and electrically connect with a further electrical connector mounted on a motor housing located in a use position relative to the chassis, the printer further comprising a printer head electrically connected to said chassis mounted electrical connector.

The chassis may further comprise means for mounting on the chassis a printer head. The aforementioned means for mounting a printer head may comprise means for releasably securing a printer head to the chassis. Preferably, the means for securing a printer head comprises a resilient snap lock clip. The chassis may comprise a printer head. Ideally, the chassis comprises means for mounting on the chassis a scanner head for scanning documents.

A second aspect of the present invention provides a printer assembly comprising the aforementioned chassis and further comprising at least one sheet of paper to be printed, said paper being located within the chassis. The printer assembly preferably comprises between 50 and 150 sheets of paper.

A third aspect of the present invention provides a printer comprising a chassis or printer assembly as hereinbefore described.

It will be understood therefore that the present invention provides a printer wherein the chassis is disposable and biodegradable. The chassis of any printer essentially performs a secondary function of providing support for both the paper to be printed and the components used during the printing process (such as the stepper motor, control/power PCBs, printer head and drive train associated with the motor). In view of this secondary function, in the present invention the chassis may be manufactured from relatively inexpensive materials using inexpensive processes and may be replaced as a disposable item. In other words, in accordance with the present invention, replacement paper and ink may be provided in a single package together with a disposable and biodegradable printer chassis. The printer chassis may itself form the packaging for the paper and ink. The chassis itself may be provided with appropriate mounting means for receiving primary components associated with a printer. These primary components are generally the more expensive components which do not need to be frequently replaced and may therefore be re-used once the paper and ink has been exhausted. Once suitable access apertures have been opened in the chassis of the present invention, the primary components may be located in position so as to complete the printer facility and allow connection to a computer and subsequent printing of documents.

Generally, the quantity of ink supplied in the ink/paper/chassis combination will be just sufficient to print the quantity of paper supplied. In other words, if 100 sheets of paper are supplied in the package, then the ink supplied in the printer head will be sufficient to print this number of pages without leaving an undesirably high and wasteful quantity of ink after the paper supply has been exhausted. Ideally, exhaustion of the paper and ink supplies should coincide. In this way, ink and paper waste is minimised.

Once the ink and paper supply has been exhausted, the primary components of the printer may be released and removed from the chassis. The chassis and empty printer head may then be disposed of. The primary components may then be reused together with a further ink/paper/chassis combination. Indeed, it may be that the chassis can be returned to the manufacturer for reconditioning and subsequent resale.

It will be understood that the present invention provides the advantages of a printing system which is relatively inexpensive to use. A printer may be purchased with the primary components installed and, due to the disposable nature of the printer chassis, the overall package will be considerably less expensive than a conventional printer. When the paper and ink sources are exhausted, the user purchases replacement sources, the packaging of which forms a chassis for mounting the primary printer components. The packaging for the paper and ink is not therefore wasted. Also, because the ink is supplied in sufficient quantity to print all supplied sheets of paper, the user may refer to the number of sheets remaining and decide whether or not this quantity is sufficient without concerning himself with the remaining supply of ink. This makes the present invention of particular use as a portable system.

Embodiments of the present invention will now be described with reference to the accompanying drawings, in which:

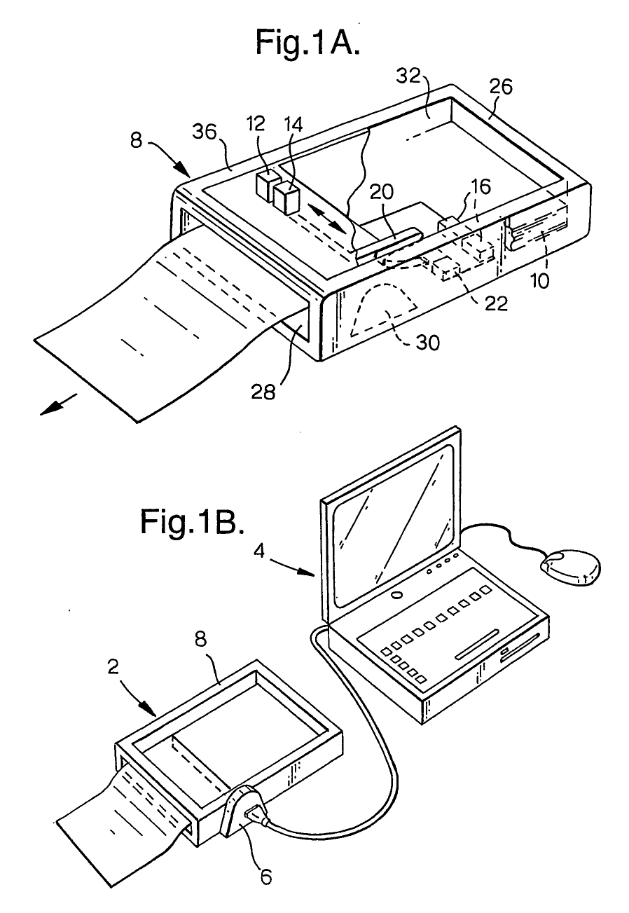

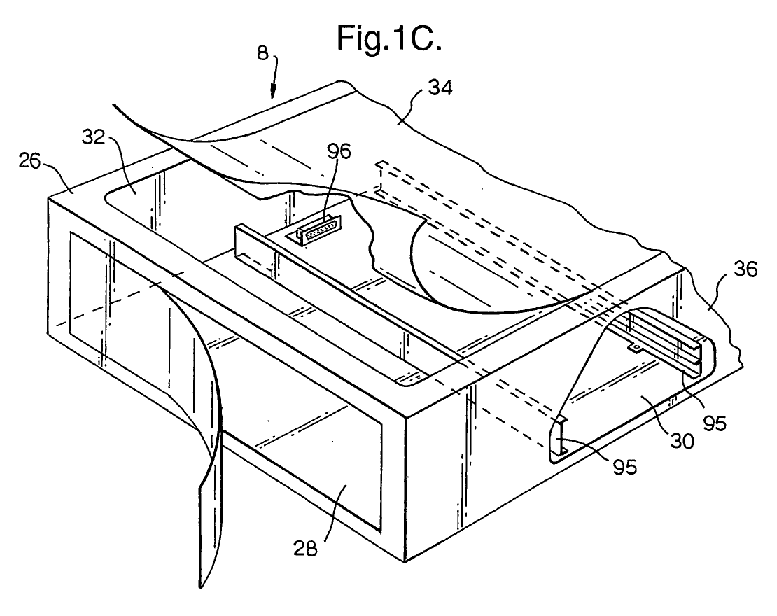

FIG. 1A is a schematic perspective view of a printer according to the present invention;

FIG. 1B is a schematic perspective view of the printer of FIG. 1A connected to a laptop personal computer,

FIG. 1C is a partial schematic perspective view of the printer of FIG. 1A wherein wax paper on the printer chassis is partly removed;

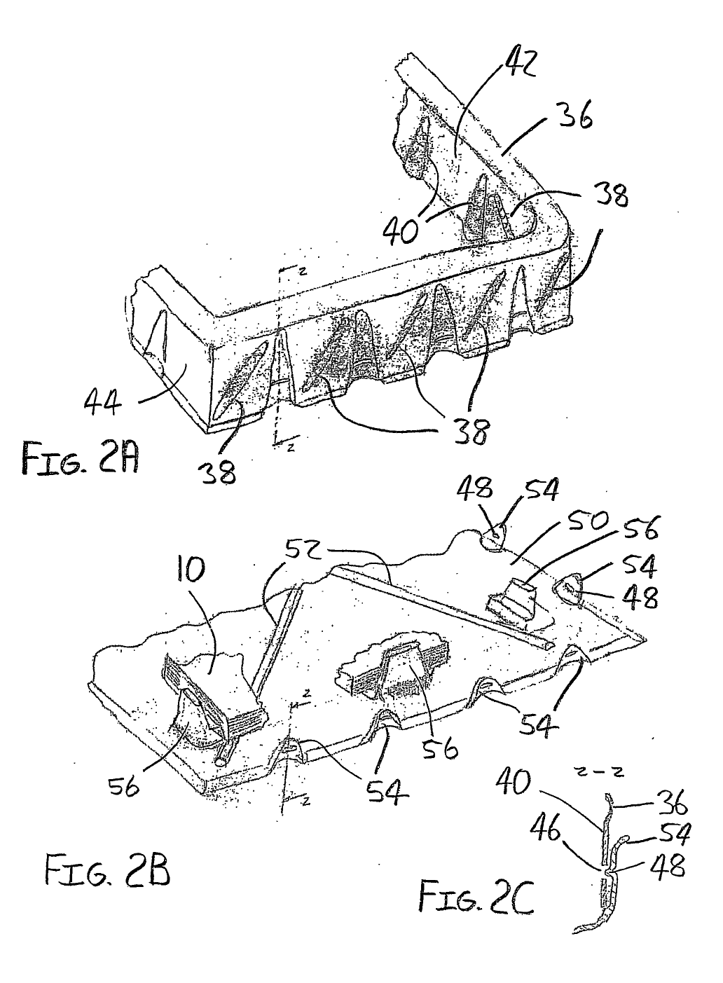

FIG. 2A is a partial schematic perspective view of the upstanding walls of the chassis of the printer shown in FIG. 1;

FIG. 2B is a partial schematic perspective view of the base of the chassis of the printer shown in FIG. 1;

FIG. 2C is a partial cross-sectional view along the lines Z-Z shown in FIGS. 2A and 2B;

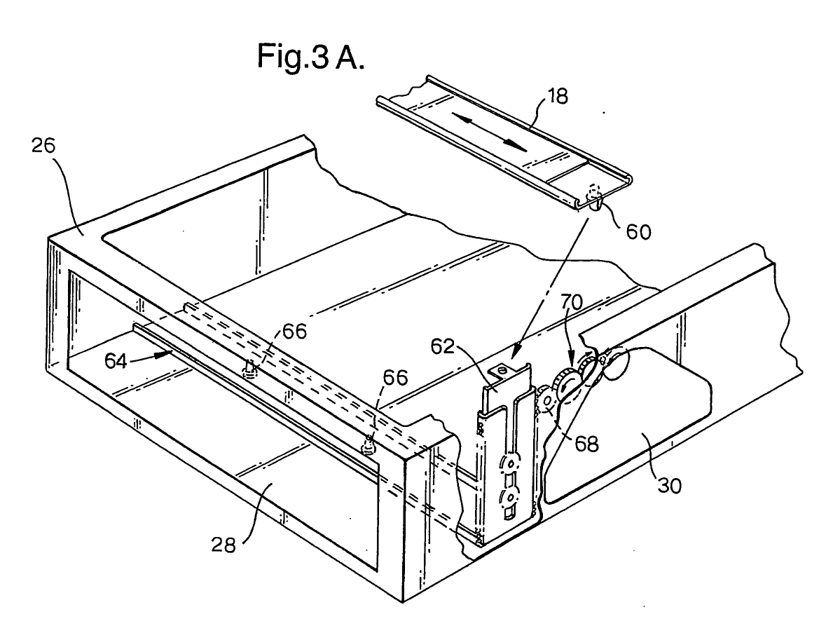

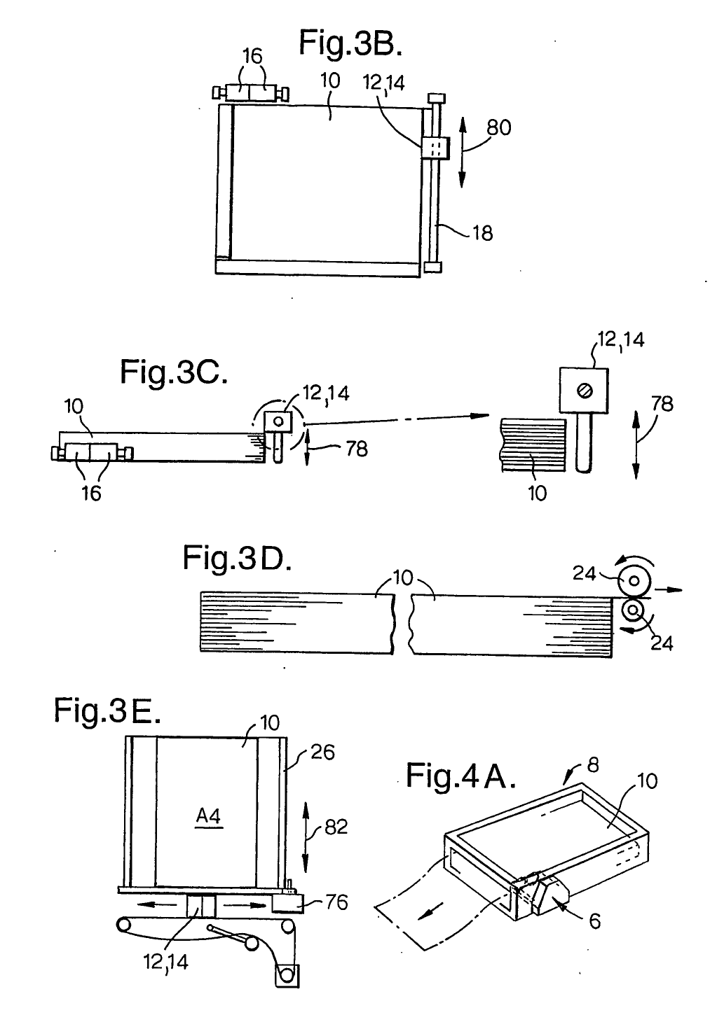

FIG. 3A is a partial schematic perspective view of a paper height adjustment mechanism of the printer shown in FIG. 1;

FIG. 3B is a schematic plan view of the printer head transverse slider of the printer shown in FIG. 1;

FIG. 3 is a schematic side view of the printer head vertical slider of the printer shown in FIG. 1;

FIG. 3D is a schematic side view of counter rotating paper manipulation rollers of the printer shown in FIG. 1;

FIG. 3E is a schematic plan view of the printer head longitudinal slider of the printer shown in FIG. 1;

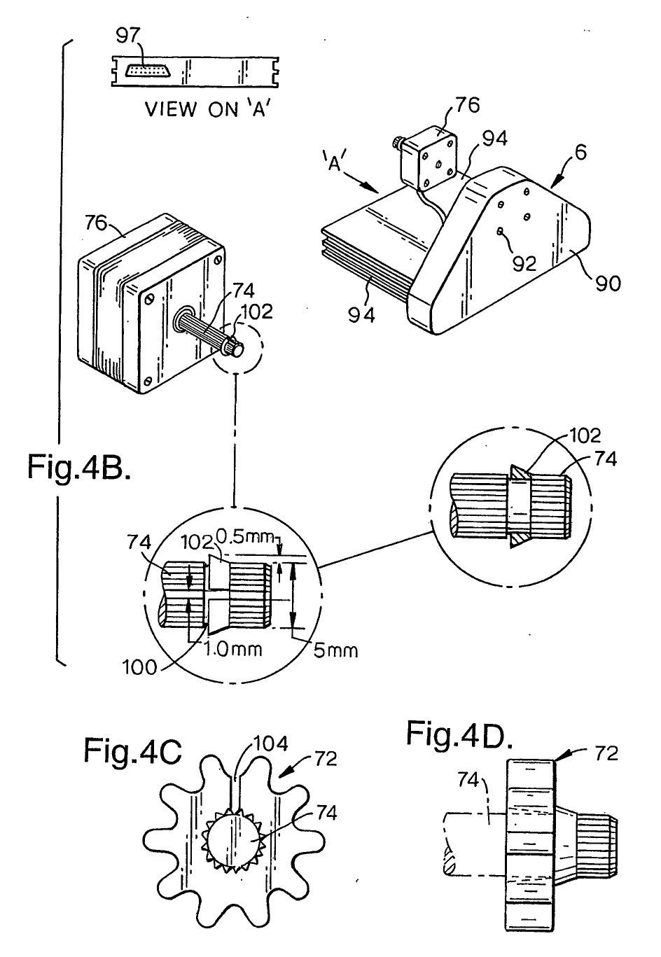

FIG. 4A is a schematic perspective view of the printer shown in FIG. 1 with a stepper motor and power/control PCBs assembly engaged therewith;

FIG. 4B is a composite view of the motor and power/control PCBs assembly and components associated therewith;

FIG. 4C is a schematic end view of a motor drive sprocket; and

FIG. 4D is a schematic side view of the drive sprocket of FIG. 4C mounted on the drive shaft of the motor shown in FIG. 4B.

A printer 2 according to the present invention is shown in an assembled state in FIG. 1B of the accompanying drawings. The printer 2 is shown in FIG. 1B connected to a laptop personal computer 4. The electrical connection between the printer 2 and the laptop 4 is made via a motor and control/power PCBs assembly 6 which is releasably secured to a chassis 8 of the printer 2. Although the printer 2 is shown in FIG. 1 lying to one side of the laptop 4, the chassis 8 of the printer 2 may be provided with suitable snap lock clips (or other securing means) for releasably securing the chassis 8 to a surface (preferably the bottom surface) of the laptop computer 4.

The chassis 8 of the printer 2 is shown in FIG. 1A, The motor and power/control PCBs assembly 6 is not attached to the chassis 8 in FIG. 1A. Although the printer 2 may be sold in practice as an assembled functioning printer, it is anticipated that the chassis alone (together with certain consumable components) as shown in FIG. 1A will generally be purchased by a user. The motor assembly 6 can be transferred from chassis to chassis as required.

Preferably, the chassis 8 is provided with components which can generally be regarded as consumable during use of a printer. The chassis 8 therefore is provided with a quantity of paper 10 to be printed (typically between 50 and 150 sheets), colour and black ink cartridges 12, 14 and a power source (for example 2 ×9v batteries 16). Exhaustion of these components ideally coincides at the end of life of the printer. In order for the chassis 8 to be readily usable by a purchaser, the ink cartridges 12, 14 are provided mounted on a transverse slider 18 and are connected to appropriate electrical circuitry by means of a standard ribbon cable 20. One or more USB or other data ports 22 may also be provided as deemed necessary. The chassis 8 may also be provided with drive train sprockets/belts for lining the motor assembly 6 to the ink cartridges 12, 14 and counter rotating rollers 24 (see FIG. 3D) for manipulating the paper 10. However, it will be appreciated that these components are not consumable and, accordingly, their provision with the chassis 8 itself should be minimised. Ideally, these components should be removably secured to the chassis 8 so that, once the consumable components have been exhausted, they may be removed from the chassis 8 and used with a new chassis.

With reference to FIG. 1A, it can be seen that the body 26 of the chassis 8 is provided with both a paper aperture 28 (through which printed paper may be ejected) and a motor assembly aperture 30 (to which the motor assembly 6 may be located and secured). It will also be seen with reference to FIG. 1A that the chassis body 26 has a large aperture 32 in its upper surface. This large aperture 32 provides full access to the interior of the chassis 8.

The chassis body 26 is manufactured from a disposable and biodegradable material (for example, recycled natural pulp fibre). The outer surface of this material is coated with wax paper 34 so as to ensure the chassis 8 remains impervious to the ingress of water. Indeed, the chassis apertures 28, 30, 32 are also covered by the wax paper 34 so that the chassis body 26 is completely encapsulated by the waterproofing material (see FIG. 1C). Of course, prior to use of the chassis 8, the portions of waterproofing material covering the apertures 28, 30, 32 must be removed and this task is assisted by providing the waterproofing material with a perforated or scored line about each aperture and along which the waterproofing material may be readily torn. If the chassis 8 is provided with USB ports, then these should also be covered in the waterproofing material.

Just as the paper, ink and power supplies of the chassis 8 are consumable, the chassis body 26 is itself intended to be consumable inasmuch as it is manufactured from materials and using processes which render the chassis body sufficiently inexpensive for a user to be able to simply discard it once the paper, ink and power supplies have been exhausted. Nevertheless, the chassis body 26 must have sufficient structural integrity to perform its function of housing the paper supply and providing a base upon which the motor assembly and ink cartridges (ie printer heads) can be mounted. To this end, the chassis body 26 may be press moulded with production steel and gauze dyes. A person skilled in production engineering will be familiar with this and other suitable manufacturing techniques. The structure of the chassis body 26 is also designed in such a way as to maximise bending resistance. For example, a honeycomb construction is provided for the base of the chassis body 28 whilst diagonal cross members may be used to further strengthen the structure. The thickness of the pulp fibre material used in constructing the body 28 is also varied and is increased at points of high stress. Optimisation of the construction may be achieved with Finite Element Analysis so as to minimise the volume of material used.

With particular reference to FIGS. 2A to 2C, it will be seen that, in the embodiment described herein, the chassis body 26 is assembled from two separate components. The first of these components is the peripheral upstanding side walls 36 in which the paper and motor assembly apertures 28, 30 are provided. A partial view of the side walls 36 taken from the rear of the chassis 8 (ie from the end opposite to the end provided with the paper aperture 28) is shown in FIG. 2A. It will be seen that the interior and exterior vertical surfaces of the side walls 36 are provided with diagonal cross members 38 projecting therefrom. These cross members assist in providing the chassis 8 with the required degree of rigidity. The side walls 36 are also provided with vertically extending buttress members 40 which extend from the inner surface 42 of the side walls 36. On the exterior surface 44 of the side walls 36 opposite each buttress member 40, the side walls 36 are sculpted inwardly and provided with an aperture 46 (or recess) for receiving one of a plurality of snap fit members 48 provided on the second component (see FIG. 2B) of the chassis 8. The location of a snap fit member 48 within an aperture 46 is shown in FIG. 2C.

The second component of the chassis 8 is a substantially planar member 50 which forms the base of the chassis 8. With reference to FIG. 2B, it will be seen that the planar member 50 is provided with diagonal cross members 52 projecting from the upper surface of the member 50 so as to increase resistance to bending loads. The peripheral edge of the base is provided with a plurality of upstanding elements 54 positioned so as to locate within the aforementioned sculpted portions of the side walls 36. Each element 54 is resiliently flexible so that a snap fit member 48 provided thereon may snap fit into a corresponding aperture 46 in the side walls 36 when the side walls 36 and planar member 50 are located together. The upper surface of the planar member 50 is also provided with upwardly projecting members 58 for receiving and retaining in a required position paper 10 to be printed.

Although the snap fit members 48 will retain the two components of the chassis 8 together, the strength of the connection may be increased by use of a suitable adhesive.

The mechanisms for manipulating the paper 10 and ink cartridges 12, 14 with the motor assembly 6 are shown in the views of FIG. 3. The operation of such mechanisms will be readily apparent to a reader skilled in the art and suitable alternatives and improvements may be implemented whilst remaining within the scope of the invention. Ideally, as much of the aforementioned mechanisms as possible should be conveniently releasable from the chassis body 26 and transferable to a further chassis body. In this way, the mechanisms may be reused so as to reduce the cost of the chassis 8. The mechanisms may be releasable secured to the chassis body 26 by means of snap fit fasteners. The details of such fasteners will again be readily apparent to readers skilled in the art.

With reference to FIG. 3A, a mechanism is shown for adjusting the height of the paper relative to the printer head (ie ink cartridges 12, 14). Thus, as the paper source is depleted and the level of the upper sheet of paper lowers, the ink cartridges 12, 14 may be indexed downwardly. Alternatively, the mechanism of FIG. 3A may be used to raise the height of the entire paper source or lower the counter rotating rollers 24 so that they may grasp an upper sheet of paper and feed it upwardly towards the ink cartridges 12, 14. In the particular embodiment shown in FIG. 3A, the transverse slider 18 for the ink cartridges 12, 14 is releasable secured at one end, by means of a snap fit clip 60, to the vertically moveable rack 62 of a rack and pinion assembly 64. The rack and pinion assembly 64 is releasable secured to the chassis body 26 by means of snap fit clips 66. Alternatively, the assembly 64 may be screwed to the chassis body 26 and washers may be suitably located to spread the associated load. The pinion 68 of the assembly 64 is driven by a gear train 70 mounted to the chassis body 26. The gear train 70 is itself driven by a sprocket 72 mounted on the drive shaft 74 of a stepper motor 76 (see the views of FIG. 4). The rack and pinion assembly 64 may comprise nylon Zintec sliders.

The vertical movement of the printer head (ink cartridges 12, 14) by the assembly 64 is shown by the arrow 78 of FIG. 3C. The transverse movement of the printer head across the width of the paper 10 is shown by arrow 80 of FIG. 3B. Relative movement of the printer head along the length of the paper 10 may be achieved either by rotation of the rollers 24 (as shown in FIG. 3D) so as to move the paper relative to the chassis body 26 or, in an alternative embodiment, by moving the printer head relative to the chassis body 26 as shown by arrow 82 in FIG. 3E.

The mechanisms shown in the views of FIG. 3 are driven by a stepper motor 76 (or by two or more stepper motors).

The views of FIG. 4 show the motor and power/control PCBs assembly 6. The assembly 6 comprises a standard stepper motor 76 which is secured to a housing 90 of the assembly 6 by means of four screws 92. The housing 90 comprises two rail sliders 94 which are adapted to engage with corresponding sliders 95 (see FIG. 1C) located on the base of the chassis body 26 adjacent the motor assembly aperture 30. Thus, as the assembly 6 is pressed through the motor assembly aperture 30, the rail slider components 94, 95 engage with one another assisting in the correct and ready location of the assembly 6 within the chassis body 26. Indeed, as will be seen from FIG. 1C, the chassis body 26 is provided with an electrical connector 96 for connecting with a mating connector 97 on the rear of the motor assembly 6 and the rail slider components 94, 95 ensure that this connection is made correctly.

The stepper motor 76 comprises a splined drive shaft 74 for receiving the motor sprocket 72. Methods of providing a sprocket on the drive shaft of a motor are well understood and any suitable method may be used in connection with the present invention. However, in the particular embodiment shown in the views of FIG. 4, the splined shaft 74 is provided with a groove 100 for receiving a tapered circlip 102. The sprocket 72 is provided with a discontinuity 104 (ie a brake therein) which allows the sprocket 72 to expand as it is pushed onto the shaft 74 and over the circlip 102. The taper of the circlip is such that the sprocket may be pushed onto the shaft 74 but, having passed over the circlip 102, cannot then pass back over the circlip 102. The sprocket 72 may be retained in a desired position on the shaft 74 by abutment with the circlip 102 and a shoulder (not shown) provided on the shaft 74.

The present invention is not limited to the particular embodiments described above. Alternative arrangements and suitable materials will be apparent to a reader skilled in the art For example, electrical communication between the printer head and the control PCB may be achieved by means of a wireless RF link. The motor assembly 6 may also be provided with suitable fastening means for releasably securing the assembly to the chassis body 26 once located in a use position. This may be achieved with suitable snap fit fasteners. The electronic circuitry of the printer may also take power (up to 0.5 Amps) from a computer to which it is connected via a USB port Furthermore, the printer may also include a scanner head so that the apparatus can also function as a scanner. The chassis 8 may also be provided with different types of paper which may be selected depending upon the type of printing to be undertaken. For example, the chassis 8 may comprise a first paper bin for standard printing paper and a second paper bin for high quality gloss photographic paper. The control circuitry of the printer will be such that paper from the appropriate bin will be selected depending upon the print job. In yet a further alternative, the ink cartridges and transverse slider may be stored in a folded state for storage and shipment purposes. Prior to use, the cartridges and slider are twisted through 90° and snapped into a use position on the chassis body 26.

1. A package of paper comprising a container manufactured from a disposable and biodegradable material; and at least one sheet of paper stored within the interior of the container; wherein the container comprises mounting means for allowing a releasable attachment to the container of one or more electrical components for printing onto a sheet of paper stored within the container interior; and a portion of the container is movable relative to the remainder of the container so as to open an access aperture providing access to the container interior so as to allow for said attachment of a component by use of said mounting means.

2. A package of paper as claimed in claim 1, wherein the container is manufactured from pulp fibre.

3. A package of paper as claimed in claim 1, wherein the container comprises a honeycomb construction.

4. A package of paper as claimed in claim 1, wherein an outer surface of the container is covered in a waterproofing material.

5. A package of paper as claimed in claim 4, wherein said waterproofing material completely encapsulates the container.

6. A package of paper as claimed in claim 5, wherein a line of perforations is provided in said waterproofing material adjacent an aperture in the container, said waterproofing material covering said aperture and said line of weakness extending around said aperture so as to provide said portion of the container movable relative to the remainder of the container.

7. A package of paper as claimed in claim 1, wherein said mounting means comprises a resilient snap lock clip.

8. A package of paper as claimed in claim 1, wherein said mounting means comprises means for mounting a motor to the container.

9. A package of paper as claimed in claim 8, wherein said means for mounting a motor comprises a rail slider upon which a motor may be located and slid into a use position.

10. A package of paper as claimed in claim 1, wherein an electrical connector is mounted on the container so as to receive and electrically connect with a further electrical connector mounted on a motor housing located in a use position relative to the container.

11. A printer chassis manufactured from a disposable and biodegradable material.

12. A printer chassis as claimed in claim 11, wherein the chassis is manufactured from pulp fibre.

13. A printer chassis as claimed in claim 11, wherein the chassis comprises a honeycomb construction.

14. A printer chassis as claimed in claim 11, wherein an outer surface of the chassis is covered in a waterproofing material.

15. A printer chassis as claimed in claim 14, wherein said waterproofing material completely encapsulates the chassis.

16. A printer chassis as claimed in claim 15, wherein a line of perforations is provided in said waterproofing material adjacent an aperture in the chassis, a portion of said waterproofing material covering said aperture and said line of weakness extending around said aperture so as to allow ready removal of said portion of material.

17. A printer chassis as claimed in claim 14, wherein said waterproofing material is bonded to the chassis.

18. A printer chassis as claimed in claim 14, wherein said waterproofing material is wax paper.

19. A printer chassis as claimed in claim 14, further comprising means for mounting on the chassis a motor for driving relative movement between a printer head and paper to be printed.

20. A printer chassis as claimed in claim 19, wherein said means for mounting a motor comprises means for releasably securing a motor to the chassis.

21. A printer chassis as claimed in claim 20, wherein said releasable securing means comprises a resilient snap lock clip.

22. A printer chassis as claimed in claim 19, wherein said means for mounting a motor comprises a rail slider upon which, in use, a motor may be located and slid into a use position.

23. A printer chassis as claimed in claim 14, wherein an electrical connector is mounted on the chassis so as to receive and electrically connect with a further electrical connector mounted on a motor housing located in a use position relative to the chassis, the printer further comprising a printer head electrically connected to said chassis mounted electrical connector.

24. A printer chassis as claimed in claim 14, further comprising means for mounting on the chassis a printer head.

25. A printer chassis as claimed in claim 24, wherein said means for mounting a printer head comprises means for releasably securing a printer head to the chassis.

26. A printer chassis as claimed in claim 25, wherein said releasable securing means comprises a resilient snap lock clip.

27. A printer chassis as claimed in claim 14, further comprising a printer head.

28. A printer chassis as claimed in claim 14, further comprising means for mounting on the chassis a scanner head for scanning documents.

29. A printer assembly comprising a chassis as claimed in claim 14, further comprising at least one sheet of paper to be printed, said paper being located within the chassis.

30. A printer assembly as claimed in claim 29, comprising between 50 and 150 sheets of paper.

31. A printer comprising a chassis as claimed in claim 11.

32. A printer comprising a printer assembly as claimed in claim 29.
